(19) United States
(12) Patent Application Publication
(10) Pub. No.: US 2015/0220556 A1
(43) Pub. Date: Aug. 6, 2015

(54) METHODS, APPARATUSES AND COMPUTER PROGRAM PRODUCTS FOR PROVIDING A PROTOCOL TO RESOLVE SYNCHRONIZATION CONFLICTS WHEN SYNCHRONIZING BETWEEN MULTIPLE DEVICES

(71) Applicant: NOKIA CORPORATION, Espoo (FI)

(72) Inventors: Petteri Lunden, Espoo (FI); Osman Yilmaz, Espoo (FI); Carl Wijting, Espoo (FI)

(21) Appl. No.: 14/428,910

(22) PCT Filed: Sep. 18, 2012
(86) PCT No.: PCT/IB2012/054949

§ 371 Date: Mar. 17, 2015

(51) Int. Cl. G06F 17/30

(52) U.S. Cl. CPC G06F 17/30174

(57) ABSTRACT

An apparatus for resolving synchronization conflicts includes a processor and memory storing executable computer program code causing the apparatus to at least perform operations including receiving an indication from a first communication device specifying data for synchronization at a designated time in the future and receiving a message from a second communication device to synchronize the data at an assigned time prior to the designated time. The computer program code may further cause the apparatus to detect a synchronization conflict, pertaining to the data, among the first and second communication devices based on evaluating information of the indication and the message. The computer program code may further cause the apparatus to provide a request to the first communication device to fetch content associated with the data to enable synchronization of the data at a dedicated time prior to the assigned time. Corresponding methods and computer program products are also provided.

### TECHNOLOGICAL FIELD

An example embodiment of the invention relates generally to wireless communication technology and, more particularly, relates to a method, apparatus, and computer program product for cloud services management to resolve synchronization conflicts.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase ease of information transfer relates to the delivery of services to a user of a mobile terminal. The services may be in the form of a particular media or communication application desired by a user(s), such as a music player, a game player, an electronic book, short messages, email, content sharing, etc. The services may be provided by a cloud services system supporting data of multiple users.

Cloud computing allows shared resources to be provided to devices over a network connection, such as the Internet. For example, cloud computing may provide, for example, computation, software applications, data access, location, commerce, or storage services. The end-user of these services may not require knowledge of the physical location or configuration of the cloud computing system that delivers the services. Some end-users may even access cloud computing services wirelessly, such as via a cellular network or a Wireless Local Area Network (WLAN).

Existing cloud computing services may deprioritize tasks which may be suspended in favor of other tasks until a better fit (in terms of data rate, power consumption, etc.) becomes available so that network resources may be used more efficiently and distributed on a larger time interval rather than instantaneous decisions. On the other hand, because of the fact that there may be conflicts experienced by cloud computing services due to delayed or postponed synchronization tasks, there may be a need for a protocol to resolve potential synchronization conflicts while synchronizing between multiple devices.

### SUMMARY

A method, apparatus and computer program product are therefore provided for providing a protocol to resolve synchronization conflicts of multiple devices being managed by a cloud network device in an efficient and reliable manner.

An example embodiment may provide a manner in which to minimize synchronization conflicts between multiple devices being managed by a cloud service by applying the following protocol.

A first communication device (e.g. Device A) may send a flag (e.g., a message) to a cloud network device indicating that there is data (e.g., a document, media content (e.g., images), etc.) to be synchronized without actually synchronizing the data at this time but rather informing the cloud network device that the data is to be synchronized at some future time. In an instance in which a second communication device (e.g., Device B) wants to modify or access the same data (e.g., a same document, etc.) in the cloud network device, the second communication device may send the cloud network device a message indicating its desire to modify or access the data. In this regard, the cloud network device may send the second communication device (e.g., Device B) a message warning the second communication device of a synchronization conflict, and/or may send a message to the first communication device (e.g., Device A) to fast fetch data from the first communication device. In an instance in which the first communication device decides to fast fetch the data, the first communication device may provide the data to the cloud network device at a time prior to the scheduled time in which the first communication device initially planned to provide the data to the cloud network device for synchronization in the future.

On the other hand, an inverse scenario may also exist. For example, in an instance in which the second communication device (e.g., Device B) desires to modify data on the cloud network device, the cloud network device may send a flag (e.g., a message) to the first communication device (e.g., Device A) that a change to the data occurred. In this regard, the first communication device (e.g., Device A) may fetch data (e.g., a same document) at a subsequent time or may fast fetch data and provide the fetched data to the cloud network device in an instance in which a user of the first communication device wants to modify corresponding data (e.g., a same document, etc.) stored on the cloud network device. Alternatively, the first communication device may fetch the data when required, for example, in an instance in which the synchronization of data stored or managed by the cloud network device is urgent.

In this regard, an example embodiment may resolve conflicts in an instance of delayed synchronization between applications running in multiple devices and a cloud network device(s). Additionally, an example embodiment may postpone synchronization by utilizing solutions to optimize connectivity to one or more networks. The optimization may, for example, be based on the availability of the network connectivity and specific characteristics of communication devices.

In an example embodiment, a method for providing a protocol to resolve synchronization conflicts when synchronizing multiple devices in a cloud device is provided. The method may include receiving an indication from a first communication device specifying data to be synchronized at a designated time in the future or at an unspecified time in the future. The method may further include receiving a message from a second communication device to synchronize the data at an assigned time that is prior to the designated time. The method may further include detecting a synchronization conflict, pertaining to the data, among the first communication device and the second communication device based in part on evaluating information of the indication and the message. The method may also include enabling provision of a request to the first communication device requesting fetching of content associated with the data to enable synchronization of the data at a dedicated time prior to the assigned time.

In another example embodiment, an apparatus for providing a protocol to resolve synchronization conflicts when synchronizing multiple devices in a cloud device is provided. The apparatus may include a processor and a memory including computer program code. The memory and computer program code are configured to, with the processor, cause the apparatus to at least perform operations including receiving an indication from a first communication device specifying data to be synchronized at a designated time in the future or at an unspecified time in the future. The memory and computer program code are further configured to, with the processor, cause the apparatus to receive a message from a second communication device to synchronize the data at an assigned time that is prior to the designated time. The memory and computer program code are further configured to, with the processor, cause the apparatus to detect a synchronization conflict, pertaining to the data, among the first communication device and the second communication device based in part on evaluating information of the indication and the message. The memory and computer program code are further configured to, with the processor, cause the apparatus to enable provision of a request to the first communication device requesting fetching of content associated with the data to enable synchronization of the data at a dedicated time prior to the assigned time.

In another example embodiment, a computer program product for providing a protocol to resolve synchronization conflicts when synchronizing multiple devices in a cloud device is provided. The computer program product includes at least one computer-readable storage medium having computer-readable program code portions stored therein. The computer-executable program code instructions may include program code instructions configured to cause receipt of an indication from a first communication device specifying data to be synchronized at a designated time in the future or at an unspecified time in the future. The program code instructions may also be configured to cause receipt of a message from a second communication device to synchronize the data at an assigned time that is prior to the designated time. The program code instructions may also be configured to detect a synchronization conflict, pertaining to the data, among the first communication device and the second communication device based in part on evaluating information of the indication and the message. The program code instructions may also be configured to enable provision of a request to the first communication device requesting fetching of content associated with the data to enable synchronization of the data at a dedicated time prior to the assigned time.

In another example embodiment, an apparatus for providing a protocol to resolve synchronization conflicts when synchronizing multiple devices in a cloud device is provided. The apparatus may include means for receiving an indication from a first communication device specifying data to be synchronized at a designated time in the future or at an unspecified time in the future. The apparatus may also include means for receiving a message from a second communication device to synchronize the data at an assigned time that is prior to the designated time. The apparatus may also include means for detecting a synchronization conflict, pertaining to the data, among the first communication device and the second communication device based in part on evaluating information of the indication and the message. The apparatus may also include means for enabling provision of a request to the first communication device requesting fetching of content associated with the data to enable synchronization of the data at a dedicated time prior to the assigned time.

In another example embodiment, a system for providing a protocol to resolve synchronization conflicts when synchronizing multiple devices in a cloud device is provided. The system may include a cloud network device and a plurality of communication devices. The cloud network device includes at least one first processor and at least one first memory including first computer program code. The at least one first memory and the first computer program code is configured to, with the at least one first processor, cause the cloud network device to perform at least the following operations including receiving an indication from a first communication device of the devices specifying data to be synchronized at a designated time in the future or at an unspecified time in the future. The first memory and the first computer program code are further configured to, with the first processor, cause the apparatus to receive a message from a second communication device of the devices to synchronize the data at an assigned time that is prior to the designated time. The first memory and the first computer program code are further configured to, with the first processor, cause the apparatus to detect a synchronization conflict, pertaining to the data, among the first communication device and the second communication device based in part on evaluating information of the indication and the message. The first memory and the first computer program code are further configured to, with the first processor, cause the apparatus to enable provision of a request to the first communication device requesting fetching of content associated with the data to enable synchronization of the data at a dedicated time prior to the assigned.

### BRIEF DESCRIPTION OF THE SEVERAL VIEWS OF THE DRAWINGS

Having thus described some example embodiments of the invention in general terms, reference will now be made to the accompanying drawings, which are not necessarily drawn to scale, and wherein:

FIG. 1 is a schematic block diagram of a system according to an example embodiment of the invention;

FIG. 2 is a schematic block diagram of an apparatus according to an example embodiment of the invention;

FIG. 3 is a schematic block diagram of a network device according to an example embodiment of the invention;

FIG. 4 is a schematic block diagram of a system according to an example embodiment of the invention;

FIG. 5 is a diagram of a signal flow for resolving synchronization conflicts among communication devices according to an example embodiment of the invention; and

FIG. 6 illustrates a flowchart for resolving synchronization conflicts among communication devices according to an example embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

An example embodiment may resolve synchronization conflicts when synchronizing data in a cloud device on behalf of multiple devices. In this regard, a first communication device may send a flag to a cloud network device indicating that there is a data to be synchronized at some designated time in the future. In an instance in which a second device desires to modify or access the data in the cloud network device, the cloud network device may warn the second communication device about the conflict, or may fast fetch the data from the first communication device. Conversely, in an instance in which the second device modifies the data on the cloud network device, the cloud network device may send a flag to the first communication device that a change to corresponding data occurred. In this regard, the first communication device may fetch the data at a subsequent time or may fast fetch the data in an instance in which a user of the first communication device desires to modify the data or fetches the data when required.

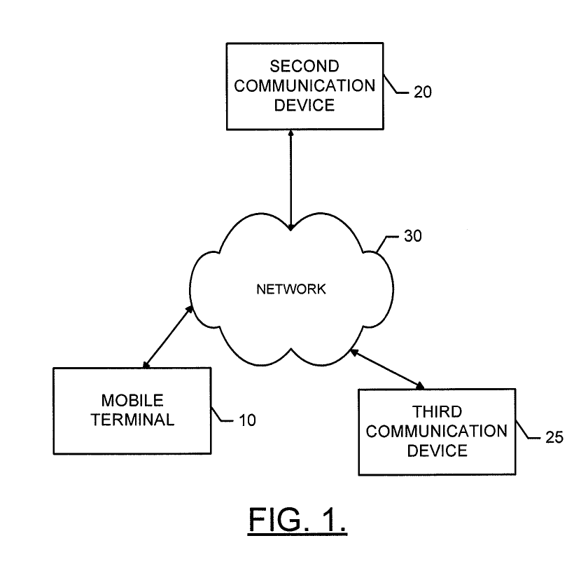

FIG. 1 illustrates a generic system diagram in which a device such as a mobile terminal 10 is shown in an example communication environment. As shown in FIG. 1, an embodiment of a system in accordance with an example embodiment of the invention may include a first communication device (e.g., mobile terminal 10) and a second communication device 20 capable of communication with each other via a network 30. In some cases, an embodiment of the invention may further include one or more additional communication devices, one of which is depicted in FIG. 1 as a third communication device 25. In one embodiment, not all systems that employ an embodiment of the invention may comprise all the devices illustrated and/or described herein. While an embodiment of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, Bluetooth headsets, Universal Serial Bus (USB) devices, electronic books (e-books), tablets (e.g., tablet computing devices) or any combination of the aforementioned, and other types of voice and text communications systems, can readily employ an embodiment of the present invention. Furthermore, devices that are not mobile, such as servers, network elements, and personal computers may also readily employ an embodiment of the invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all-inclusive or detailed view of the system or the network 30. Although not necessary, in one embodiment, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), LTE advanced (LTE-A) and/or the like. In one embodiment, the network 30 may be a point-to-point (P2P) network.

One or more communication terminals such as the mobile terminal 10 and the second and third communication devices 20 and 25 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a Local Area Network (LAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other, for example, according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 (e.g., user equipment) and the second and third communication devices 20 and 25 may communicate in accordance with, for example, radio frequency (RF), near field communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (WiFi), Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an example embodiment, the first communication device (e.g., the mobile terminal 10) may be a mobile communication device such as, for example, a wireless telephone or other devices such as a personal digital assistant (PDA), mobile computing device, camera, video recorder, audio/video player, positioning device, game device, television device, radio device, or various other like devices or combinations thereof. The second communication device 20 and the third communication device 25 may be mobile or fixed communication devices. However, in one example, the second communication device 20 and the third communication device 25 may be network devices, servers, remote computers or terminals such as, for example, personal computers (PCs) or laptop computers. In one example embodiment, the second communication device 20 and/or third communication device 25 may be cloud computing devices that provide cloud services associated with sharing of resources, data, etc. among multiple communication devices (e.g., mobile terminals 10).

In an example embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities.

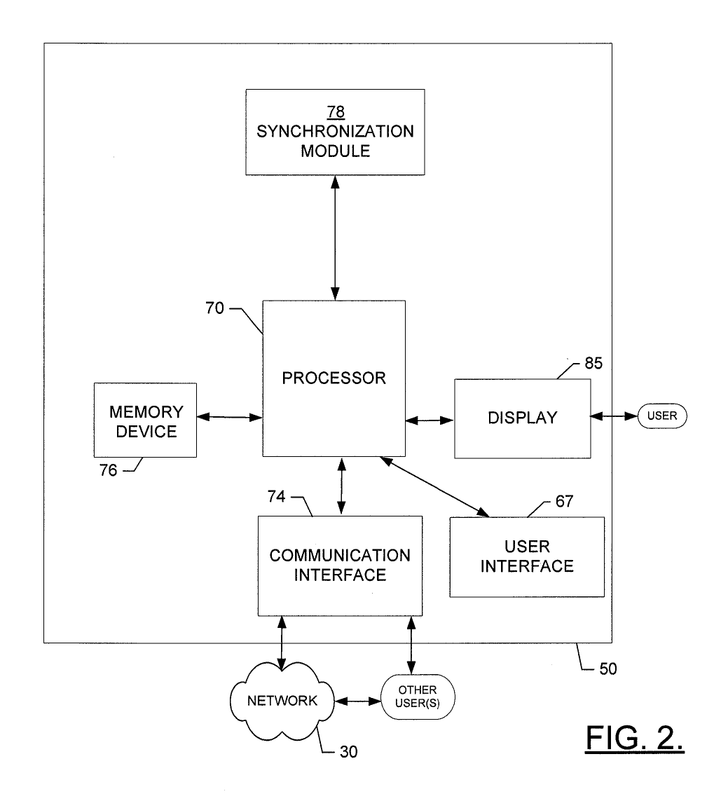

In an example embodiment, the mobile terminal 10 and the second and third communication devices 20 and 25 may employ an apparatus (e.g., apparatus of FIG. 2) capable of employing an embodiment of the invention.

FIG. 2 illustrates a schematic block diagram of an apparatus for sharing one or more items of media content of a playlist according to an example embodiment of the invention. An example embodiment of the invention will now be described with reference to FIG. 2, in which certain elements of an apparatus 50 are displayed. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, an embodiment may be employed on a combination of devices. Accordingly, one embodiment of the invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in a certain embodiment.

Referring now to FIG. 2, the apparatus 50 may include or otherwise be in communication with a processor 70, a user interface 67, a communication interface 74, a memory device 76, a display 85, and a synchronization module 78. The memory device 76 may include, for example, volatile and/or non-volatile memory. For example, the memory device 76 may be an electronic storage device (e.g., a computer readable storage medium) comprising gates configured to store data (e.g., bits) that may be retrievable by a machine (e.g., a computing device like processor 70). In an example embodiment, the memory device 76 may be a tangible memory device that is not transitory. The memory device 76 may be configured to store information, data, files, applications, instructions or the like for enabling the apparatus to carry out various functions in accordance with an example embodiment of the invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content (e.g., audio data (e.g., music), pictures, videos (e.g., music), etc.).

The processor 70 may be embodied in a number of different ways. For example, the processor 70 may be embodied as one or more of various processing means such as a coprocessor, microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an example embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to an embodiment of the invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and operations described herein when the instructions are executed. However, in some cases, the processor 70 may be a processor of a specific device (e.g., a mobile terminal or network device) adapted for employing an embodiment of the invention by further configuration of the processor 70 by instructions for performing the algorithms and operations described herein. The processor 70 may include, among other things, a clock, an arithmetic logic unit (ALU) and logic gates configured to support operation of the processor 70.

In an example embodiment, the processor 70 may be configured to operate a connectivity program, such as a browser, Web browser or the like. In this regard, the connectivity program may enable the apparatus 50 to transmit and receive Web content such as, for example, location-based content or any other suitable content, according to a Wireless Application Protocol (WAP), for example. The processor 70 may also be in communication with a display 85 and may instruct the display to illustrate any suitable information, data, content (e.g., media content) or the like.

Meanwhile, the communication interface 74 may be any means such as a device or circuitry embodied in either hardware, a computer program product, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 67 may be in communication with the processor 70 to receive an indication of a user input at the user interface 67 and/or to provide an audible, visual, mechanical or other output to the user. As such, the user interface 67 may include, for example, a keyboard, a mouse, a joystick, a display, a touch screen, a microphone, a speaker, or other input/output mechanisms. In an example embodiment in which the apparatus is embodied as a server or some other network devices, the user interface 67 may be limited, remotely located, or eliminated. The processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the processor 70 may be embodied as, include or otherwise control the synchronization module. The synchronization module 78 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the synchronization module 78 as described below. Thus, in an example in which software is employed, a device or circuitry (e.g., the processor 70 in one example) executing the software forms the structure associated with such means.

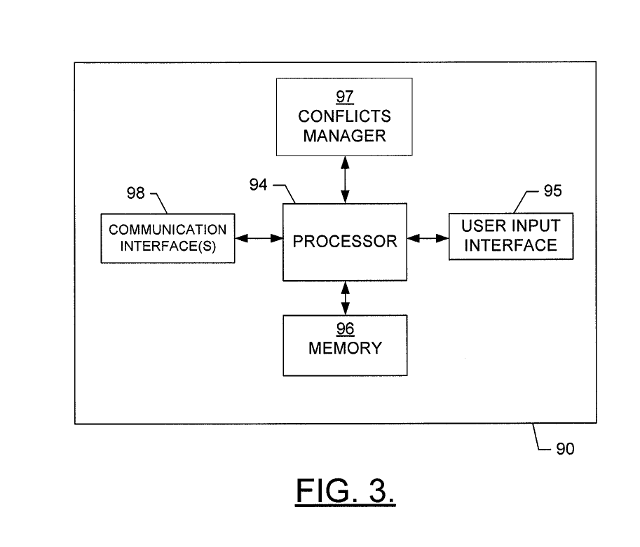

In an example embodiment, the synchronization module 78 may provide a message to a cloud network device (e.g., network device 90 of FIG. 3) indicating that data (e.g., a document, media content, a result(s) of a computation(s), or any suitable data) stored on the cloud network device on behalf of the apparatus 50 is to be synchronized by the cloud network device at a designated time (e.g., at a time T2) in the future. In an instance in which the cloud network device receives a message from another apparatus 50 indicating that the other apparatus 50 desires to modify the same data stored on, or maintained by, the cloud network device at a time (e.g., T1) before the designated time (e.g., T2) in the future, the cloud network device may provide a message to the other apparatus 50 that includes data warning the other apparatus 50 of the conflict (e.g., a synchronization conflict).

Additionally or alternatively, the conflicts manager 97 may provide a message to the apparatus 50 that desires synchronization of the data at the designated time in the future. The message may include data indicating a request to fast fetch the data to be synchronized and provide the data to the cloud network device (e.g., network device 90 of FIG. 3) at a time prior to the designated time (e.g., T2) in the future. In this regard, the apparatus 50 that initially requested synchronization of the data at the designated time (e.g., T2) in the future may optionally provide content to the cloud network device for synchronization of data at a time (e.g., at a time T0) prior to the designated time in the future (e.g., T2) and prior to the time (e.g., T1) in which the other apparatus 50 desires to access or modify the same data (where T0<T1<T2). In an instance in which the apparatus 50 decides not to fast fetch the content at a time prior (e.g., T0) to the designated time (e.g., T2) in the future, the apparatus 50 may decide to provide the content for synchronization of data to the cloud network device at the designated time (e.g., T2) in the future. For example, the apparatus 50 may be aware that a more reliable connection to a network (e.g., a WiFi connection as opposed to a cellular connection (e.g., a 3G connection)) is available or scheduled for communication at the designated time in the future (e.g., T2), as described more fully below.

Referring now to FIG. 3, a block diagram of a network device according to an example embodiment is provided. As shown in FIG. 3, the network device 90 (also referred to herein as cloud network device 90) (e.g., a server) may include a processor 94, a memory 96, a user input interface 95, a communication interface(s) 98, and a conflicts manager 97. The memory 96 may comprise volatile and/or non-volatile memory, and may store content, data and/or the like. The memory 96 may store client applications, instructions, and/or the like for the processor 94 to perform the various operations of the client network device 90. The memory 96 may be a tangible non-transitory device.

The processor 94 may be embodied in a number of different ways. For instance, the processor 94 may be embodied as one or more of various processing means such as a coprocessor, microprocessor, a controller, a DSP, processing circuitry with or without an accompanying DSP, or various other processing devices including integrated circuits such as, for example, an ASIC, an FPGA, a MCU, a hardware accelerator, a special-purpose computer chip, or the like. In an example embodiment, the processor 94 may be configured to execute instructions stored in the memory 96 or otherwise accessible to the processor 94. As such, whether configured by hardware or software methods, or by a combination thereof, the processor 94 may represent an entity (e.g., physically embodied in circuitry) capable of performing operations according to an embodiment of the invention while configured accordingly. Thus, for example, when the processor 94 is embodied as an ASIC, FPGA or the like, the processor 94 may be specifically configured hardware for conducting the operations described herein. Alternatively, as another example, when the processor 94 is embodied as an executor of software instructions, the instructions may specifically configure the processor 94 to perform the algorithms and operations described herein when the instructions are executed. However, in some cases, the processor 94 may be a processor of a specific device (e.g., a mobile terminal or network device) adapted for employing an embodiment of the invention by further configuration of the processor 94 by instructions for performing the algorithms and operations described herein. The processor 94 may include, among other things, a clock, an arithmetic logic unit (ALU) and logic gates configured to support operation of the processor 94.

The processor 94 may also be connected to a communication interface 98 or other means for displaying, transmitting and/or receiving data, content, and/or the like. The user input interface 95 may comprise any of a number of devices allowing the network entity to receive data from a user, such as a keypad, a touch display, a joystick or other input device. In this regard, the processor 94 may comprise user interface circuitry configured to control at least some functions of one or more elements of the user input interface. The processor and/or user interface circuitry of the processor may be configured to control one or more functions of one or more elements of the user interface through computer program instructions (e.g., software and/or firmware) stored on a memory accessible to the processor (e.g., volatile memory, non-volatile memory, and/or the like).

In an example embodiment, the processor 94 may be embodied as, include or otherwise control the conflicts manager 97. The conflicts manager 97 may be any means such as a device or circuitry operating in accordance with software or otherwise embodied in hardware or a combination of hardware and software (e.g., processor 94 operating under software control, the processor 94 embodied as an ASIC or FPGA specifically configured to perform the operations described herein, or a combination thereof) thereby configuring the device or circuitry to perform the corresponding functions of the conflicts manager 97 as described below. Thus, in an example in which software is employed, a device or circuitry (e.g., the processor 94 in one example) executing the software forms the structure associated with such means.

The conflicts manager 97 may manage synchronization conflicts of data among communication devices (e.g., apparatuses 50). For example, the conflicts manager 97 may inform one or more communication devices of a synchronization conflict in an instance in which the conflicts manager 97 determines that there may be a conflict in synchronizing data stored or maintained by the cloud network device on behalf of the communications devices.

The conflicts manager 97 may determine that there may be a conflict in synchronizing data in an instance in which the cloud network device 90 receives an indication or message (e.g., a flag) from a first communication device (e.g., a first apparatus 50) indicating that there is data to be synchronized at a designated time (e.g., T2) in the future and in which the cloud network device 90 receives another message from a second communication device. The message received from the second communication device (e.g., a second apparatus 50) may include data requesting to access or modify the same data at a time (e.g., T1) prior to the designated time (e.g., T2) in the future (e.g., T1<T2). Alternatively, the exact time T2 for synchronization may not be known or may not be indicated from a first communication device. Instead, the first communication device may indicate that there is data that is to be synchronized in the future without indicating when the data will be synchronized. In this instance, when a second apparatus wants to access or modify the same data immediately or at a time T1 in the future, the second apparatus may interpret that T1<T2.

In this regard, the conflicts manager 97 may send a message to the second communication device (e.g., the second apparatus 50) indicating the detected conflict. The message sent to the second communication device by the conflicts manager 97 may also request the second communication device to wait for receipt of a conflict resolution message before accessing or modifying the data. The conflicts manager 97 may also send a fast fetching request to the first communication device requesting the first communication device to fetch and provide content for synchronization of data to the conflicts manager 97 at a time (e.g., T0, where T0<T1) prior to the designated time (e.g., T2) in the future. In an alternative example embodiment, a direct communication path may be arranged between the first communication device and the second communication device for the purpose of performing a fast fetch. In this regard, for example, the synchronization may take place directly between the first communication device and the second communication device without communication with the conflicts manager 97 of the cloud network device. In one example embodiment, the first communication device and the second communication device may communicate directly via a communication path in an instance in which the first and second communication devices are physically close in proximity. In another example embodiment, the first communication device and the second communication device may communicate directly via a communication path even in an instance in which the first and second communication devices may not necessarily be physically close in proximity.

In response to receiving a fast fetching request (e.g., from the conflicts manager or the second communication device), the synchronization module 78 of the first communication device (e.g., the first apparatus 50) may decide to fast fetch the content and provide the content to the conflicts manager 97 at a time prior (e.g., at a time T0<T1<T2) to the designated time (e.g., T2) in the future to enable the conflicts manager 97 to synchronize the data. Alternatively, the synchronization module 78 of the first communication device may decide not to fast fetch the content and may instead decide to provide the content to the conflicts manager 97 of the cloud network device 90 at the designated time (e.g., T2) in the future, as described more fully below. The synchronization module 78 may, for example, decide to provide the data for synchronization at the designated time (e.g., T2) in the future in an instance in which the synchronization module 78 determines a network link quality at a prior time (e.g., T0) is low or that a connection to a network costs more at the prior time, or for any other suitable reasons. Alternatively, the synchronization module 78 may decide to provide the date for synchronization at another time that is after T1, but still before T2. This may be the case for example, in an instance in which it is not feasible to complete the synchronization before time T1, or for example in an instance in which a communication device is low on battery power and needs to conserve the battery power.

Additionally, the synchronization module 78 may be aware that a network connection is more reliable or lower in terms of cost (e.g., usage of a free WiFi network versus a cellular network in which a user pays for service) at the designated time (e.g., T2) in the future. In this regard, the synchronization module 78 may decide to provide content for synchronization to the conflicts manager 97 at the time (e.g., T2) initially designated in the future. In an alternative example embodiment, the conflicts manager 97 of the cloud network device 90 may decide not to send a fast fetch request to the first communication device. In this regard, for example, the conflicts manager 97 may decide not to send a fast fetch request to the first communication device in an instance in which the time T1 is so close to a current time that the first communication device would be unable to complete the synchronization before the time T1.

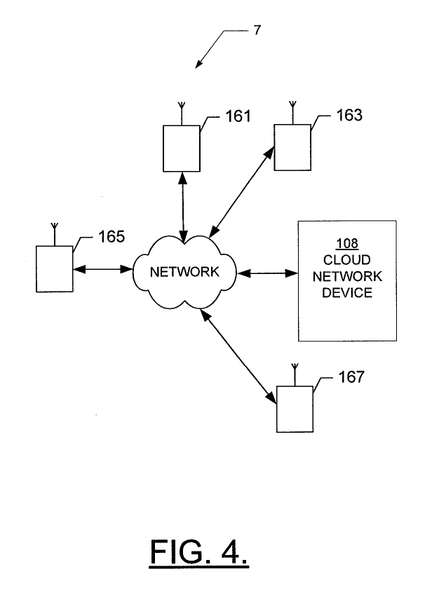

Referring now to FIG. 4, a diagram of a system according to an example embodiment is provided. The system 7 may include communication devices 161, 163, 165, 167 (e.g., apparatuses 50) and a cloud network device 108 (e.g., cloud network device 90). Although FIG. 4 shows that system 7 includes four communication devices 161, 163, 165, 167 and one cloud network device 108, it should be pointed out that system 7 may include any suitable number of communication devices 161, 163, 165, 167 and cloud network devices 108 without departing from the spirit and scope of the invention.

The cloud network device 108 may resolve synchronization conflicts of data that may be requested for modification or access by two or more of the communication devices 161, 163, 165 and 167, as described more fully below.

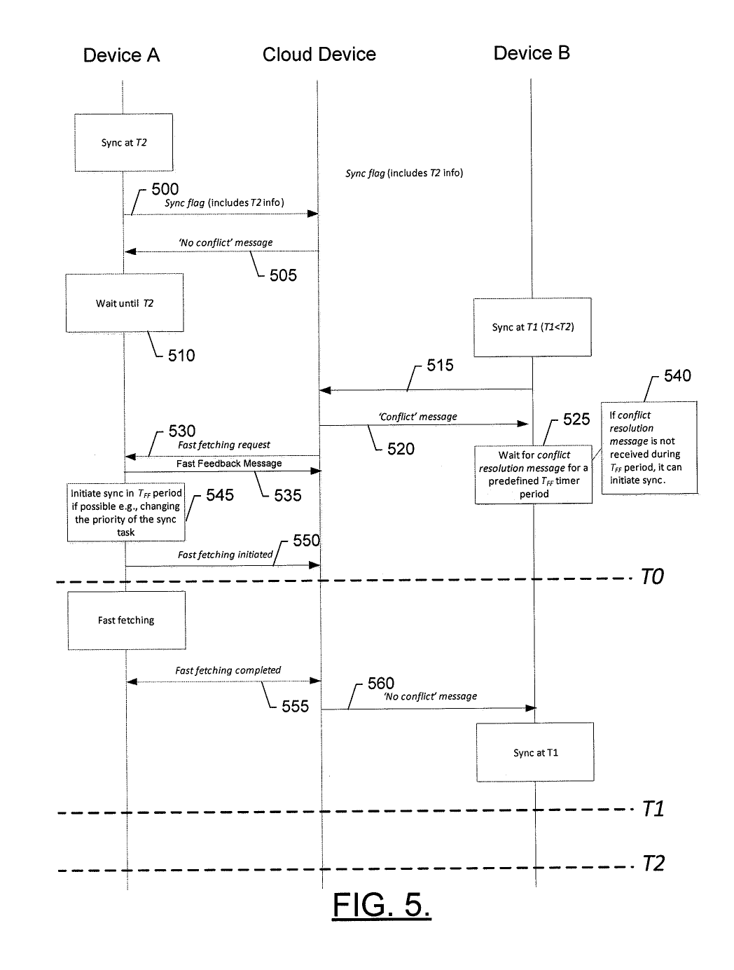

Referring now to FIG. 5, a signal flow diagram is provided for an example method of a protocol to resolve synchronization conflicts among communication devices according to an example embodiment. At operation 500, device A (e.g., communication device 161) may send an indication or flag (e.g., a message) to the cloud device (e.g., cloud network device 108) indicating that there is data to be synchronized at a designated time in the future such as, for example, time T2. For purposes of illustration and not of limitation, the cloud device may store a version of the data in a memory (e.g., memory 96) and the data designated for synchronization at time T2 may be a modified version of the data. At operation 505, in response to receipt of the flag indicating the time T2 designated for synchronization of the data, the cloud device may send device A a message indicating that there is no current synchronization conflict associated with synchronizing the data requested for synchronization in the flag.

At operation 510, device A may initially decide to wait until time T2 before retrieving content (e.g., retrieving content from a memory (e.g., memory device 76)) to be provided to the cloud device for synchronization. At operation 515, the cloud device may receive a message from device B (e.g., communication device 163) indicating a request to synchronize (e.g., update/modify) the data (e.g., the same data that device A requests to synchronize) stored on, or maintained by, the cloud device at a time T1 that is prior to the time T2 (e.g., T1<T2). At operation 520, in response to receipt of the request from device B, the cloud device may send a message to device B indicating a conflict in synchronizing the data. At operation 525, device B may wait to receive a conflict resolution message for a predefined timer period T_{FF}.

At operation 530, the cloud device may send device A a request (also referred to herein as a fast fetching request) to fast fetch data for synchronization at a time T0 prior to time T1, during a time period of a predefined timer T_{FF} which may be triggered and run by the cloud device and/or the first communication device. Optionally, at operation 535, device A may provide a fast fetch feedback message to the cloud device indicating whether device A decides to fast fetch content (e.g., a modified version of data, etc.) associated with the data for synchronization and may provide the content to the cloud device for synchronization of the data stored at, or maintained by, the cloud device at time T0.

At operation 540, in an instance in which the fast fetch feedback message indicates that the device A decided not to fast fetch the content for synchronization of data stored at, or maintained by, the cloud device at time T0, the device B may not receive a conflict resolution message from the cloud device during the predefined timer period T_{FF}. In this regard, device B may communicate with the cloud device and may provide the cloud device with content/data to initiate the synchronization of data, stored at, or maintained by, the cloud device, at time T1 per the request of device B sent previously to the cloud device. In an alternative example embodiment, the cloud device may determine that the device A decided not to fast fetch content at time T0 in an instance in which the cloud device does not receive a message (e.g., a fast fetch feedback message) from device A, in response to the fast fetching request sent to device A, prior to the expiration of the predefined timer period T_{FF}. As such, the cloud device may not send a conflict resolution message to device B prior to the expiration of the predefined timer period T_{FF} and device B may initiate the synchronization of data with the cloud device upon expiration of the predefined timer period T_{FF}. In this regard, the device B may send information to the cloud device for synchronization of the data stored at, or maintained by the cloud device, upon expiration of the predefined timer period T_{FF}. Alternatively, device A may acknowledge the fast fetch request so that the device B may be readily informed that device A is to start fast fetching. Alternatively, in an instance in which device A sends a negative acknowledgement indicating that it is not going to support fast fetch, the device B may be informed of this immediately and there is no need to wait for a timer (e.g., predefined timer period T_{FF}) to expire.

Device A may, but need not, decide to fast fetch the content from a memory (e.g., memory device 76) and provide the content to the cloud device for synchronization of the data stored at, or maintained by, the cloud device at time T0 in an instance in which device A determines that there is a reliable network connection for communicating the content to the cloud device. In another example embodiment, Device A may decide to fast fetch the content from a memory and provide the content to the cloud device for synchronization of the data stored at, or maintained by, the cloud device at time T0 in an instance in which device A determines that there is an urgent need to synchronize the data at time T0. For purposes of illustration and not of limitation, a text file modified by multiple devices/users may need to be synchronized in an urgent manner. On the other hand, synchronization of images/photos may not be as urgent as synchronizing a text file.

On the other hand, in an instance in which device A determines that there is a better or more reliable network connection (e.g., a more reliable WiFi network connection as opposed to an unreliable cellular network connection (e.g., the device A is at the edge of a cell, etc.)) at time T2 for communicating with the cloud device, the device A may decide not to fast fetch the content at time T0 and may instead decide to communicate with the cloud device at time T2 for synchronization of the data. The device A may determine that there is a better or more reliable/favorable network connection because of a lower service fee or a more energy-efficient data transfer capability or for other suitable reasons. In an alternative example embodiment, in an instance in which device A decides to synchronize data at time T2, but the device B initiated synchronization of data at time T1 there may be two copies of the updated data in the cloud network device. In one example embodiment, the conflicts manager 97 may merge these two copies.

At operation 545, in an instance in which device A decides to fast fetch the content for synchronization of data at time T0, device A may initiate the synchronization during the predefined timer period T_{FF} and a synchronization module (e.g., synchronization module 78) of the device A may change a priority of synchronization tasks from time T2 to time T0. At operation 550, device A may provide a message, at time T0, to the cloud device indicating that fast fetching is initiated. This message may include content (e.g., modified data (e.g., a version of a document, images, etc.)) that the cloud device may utilize to synchronize corresponding data (e.g., a same document or any suitable data (e.g., images, etc.)) stored at, or maintained by, the cloud device. At operation 555, the cloud device may send device A a message indicating that the fast fetching is completed and that the synchronization of the data requested by device A is complete.

At operation 560, the cloud device may send device B a message indicating that there is no synchronization conflict and the cloud device may utilize content (e.g., modified data (e.g., a different version of a same document, images, etc.)) provided by the device B to synchronize the corresponding data (e.g., a same document or any suitable data (e.g., images, etc.)) stored at, or maintained by, the cloud device at time T1 which is prior to time T2.

In an alternative example embodiment, a less strict protocol may be utilized by the cloud device (e.g., cloud network device 108) in an instance in which Device B (e.g., communication device 163) attempts to read or access the data stored on the cloud device as opposed to modifying the data. However, device A may have corresponding modified data stored locally that is not yet provided to the cloud device but is scheduled for synchronization by the cloud device at a designated time in the future (e.g., time T2). In this regard, the cloud device may send a message to device B warning device B that the data stored or maintained by the cloud device is not up-to-date.

Alternatively, in this example embodiment, the cloud device may send device A a message requesting fast fetching of the data (e.g., modified data) stored locally at device A to enable the cloud device to synchronize and update corresponding data stored at the cloud device. In this regard, the cloud device may provide the updated data to device B in response to device B requesting to access or read the data.

In the signal flow of FIG. 5, parameterization and/or messaging may be modified or replaced by the cloud device depending on the accuracy of a network connectivity prediction and task scheduling performed by a conflicts manager (e.g., conflicts manager 97). For instance, a conflicts manager of the cloud device may determine that times T1, T2 and T0 may correspond to exact synchronization times or an order of priority in performing synchronization tasks. In an instance in which the priority order is implemented by the cloud device, time T2 may indicate that device A delays a respective deprioritized synchronization until device A connects to a small cell in its proximity but not in its coverage area (e.g., at a time T2=∞ (infinity)). T1 may indicate that device B may initiate a corresponding synchronization task(s) as soon as it receives a ‘no conflict’ message from the cloud device (e.g., at a time T1=0). Additionally, in an instance in which a corresponding synchronization on behalf of device B is forced to happen only after a synchronization on behalf of device A is complete, the predefined timer period T_{FF} may be neglected or removed (e.g., T_{FF}=∞) by the conflicts manager of the cloud device. In this example embodiment, the predefined timer period T_{FF} may be neglected/removed since the conflicts manager of the cloud device may force synchronizations on behalf of device B to occur after synchronizations on behalf of device A.

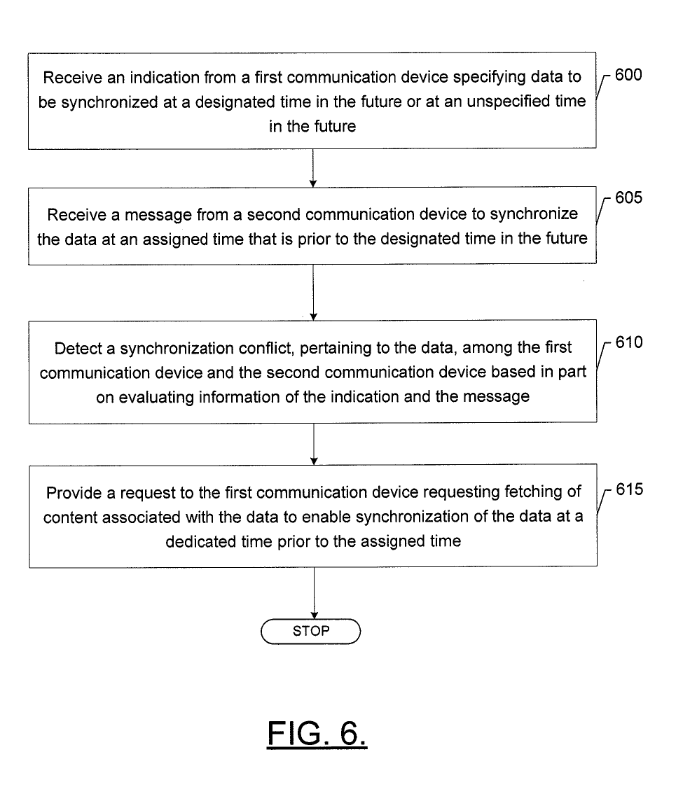

Referring now to FIG. 6, an example embodiment of a flowchart for providing a protocol to resolve synchronization conflicts when synchronizing multiple devices in a cloud device is provided. At operation 600, a cloud network device (e.g., cloud network device 108) may include means, such as the conflicts manager 97, the processor 94 and/or the like, for receiving an indication (e.g., a flag or message) from a first communication device (e.g., communication device 161) specifying data (e.g., a document, images, video data, audio data, etc.) to be synchronized at a designated time (e.g., time T2) in the future, or at an unspecified time in the future. At operation 605, the cloud network device may include means, such as the conflicts manager 97, the processor 94 and/or the like, for receiving a message from a second communication device (e.g., communication device 163) to synchronize the data (e.g., the same data) at an assigned time (e.g., time T1) that is prior to the designated time (e.g., time T2).

At operation 610, the cloud network device may include means, such as the conflicts manager 97, the processor 94 and/or the like, for detecting a synchronization conflict, pertaining to the data, among the first communication device (e.g., communication device 161) and the second communication device (e.g., communication device 163) based in part on evaluating information of the indication and the message. At operation 615, the cloud network device may include means, such as the conflicts manager 97, the processor 94 and/or the like, for providing a request (e.g., a fast fetch request) to the first communication device requesting fetching of content associated with the data to enable synchronization of the data at a dedicated time (e.g., time T0) prior to the assigned time (e.g., time T1). The content may, but need not, include a different version (e.g., version two of a document, etc.) or modification to the data requested for synchronization that is stored on, or maintained by, the cloud network device.

It should be pointed out that FIGS. 5 and 6 are flowcharts of a system, method and computer program product according to an example embodiment of the invention. It will be understood that each block of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76, memory 96) and executed by a processor (e.g., processor 70, processor 94, synchronization module 78, conflicts manager 97). As will be appreciated, any such computer program instructions may be loaded onto a computer or other programmable apparatus (e.g., hardware) to produce a machine, such that the instructions which execute on the computer or other programmable apparatus cause the functions specified in the flowcharts blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowcharts blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts blocks.

Accordingly, blocks of the flowcharts support combinations of means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the methods of FIGS. 5 and 6 above may comprise a processor (e.g., the processor 70, processor 94, synchronization module 78, conflicts manager 97) configured to perform some or each of the operations (500-560), and (600-615) described above. The processor may, for example, be configured to perform the operations (500-560), and (600-615) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (500-560), and (600-615) may comprise, for example, the processor 70 (e.g., as means for performing any of the operations described above), the processor 94, the synchronization module 78, the conflicts manager 97 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-41. (canceled)

42. An apparatus comprising:
at least one processor; and
at least one memory including computer program code, the at least one memory and the computer program code configured to, with the at least one processor, cause the apparatus to perform at least the following:
receive an indication from a first communication device specifying data to be synchronized at a designated time in the future or at an unspecified time in the future;
receive a message from a second communication device to synchronize the data at an assigned time that is prior to the designated time;
detect a synchronization conflict, pertaining to the data, among the first communication device and the second communication device based in part on evaluating information of the indication and the message; and
enable provision of a request to the first communication device requesting fetching of content associated with the data to enable synchronization of the data at a dedicated time prior to the assigned time.

43. The apparatus of claim 42, wherein the at least one memory and the computer program code are further configured to, with the processor, cause the apparatus to:
enable sending of a generated message to the second communication device warning the second communication device of the synchronization conflict.

44. The apparatus of claim 43, wherein the generated message comprises information instructing the second communication device to wait to receive a no conflict message during a predefined time period prior to initiating synchronization of the data at the assigned time.

45. The apparatus of claim 42, wherein the at least one memory and the computer program code are further configured to, with the processor, cause the apparatus to:
synchronize the data at the dedicated time in response to receiving the fetched content and an indication, from the first communication device, specifying to synchronize the data at the dedicated time.

46. The apparatus of claim 45, wherein prior to synchronize the data the at least one memory and the computer program code are further configured to, with the processor, cause the apparatus to:
receive a feedback message from the first communication device during the predefined time period indicating whether the first communication device accepts or rejects the request to fetch the content to enable the synchronization of the data at the dedicated time.

47. The apparatus of claim 45, wherein the at least one memory and the computer program code are further configured to, with the processor, cause the apparatus to:
enable provision of a message to the second communication device indicating that there is no longer a synchronization conflict and requesting information from the second communication device to synchronize the data at the assigned time.

48. The apparatus of claim 47, wherein the at least one memory and the computer program code are further configured to, with the processor, cause the apparatus to:
synchronize the data at the assigned time based in part on the information received from the second communication device.

49. The apparatus of claim 45, wherein:
the indication to synchronize the data at the dedicated time is received in response to the first communication device determining that a network connection for transfer of the content is reliable at the dedicated time or that transfer of the content costs less at the dedicated time relative to the designated time.

50. The apparatus of claim 45, wherein:
the indication to synchronize the data at the dedicated time is received from the first communication device in response to the first communication device determining that a need to synchronize the data is urgent.

51. The apparatus of claim 42, wherein the at least one memory and the computer program code are further configured to, with the processor, cause the apparatus to:
receive information from the second communication device to enable synchronization of the data at the assigned time upon expiration of a predefined time period in response to receiving a feedback message from the first communication device indicating that the first communication device decided not to enable synchronization of the data at the dedicated time or in response to detecting that the first communication device did not respond to the request to fetch the content during the predefined time period.

52. The apparatus of claim 51, wherein the at least one memory and the computer program code are further configured to, with the processor, cause the apparatus to:
synchronize the data at the designated time based in part on the content received from the first communication device in an instance in which the first communication device decides that the synchronization of the data should remain scheduled at the designated time.

53. The apparatus of claim 52, wherein:
the content is received from the first communication device in an instance in which the first communication device decides that the synchronization of the data should remain scheduled at the designated time in response to the first communication device determining that a network connection for transfer of the content is more reliable at the designated time than at the dedicated time or that the transfer of the content costs less at the designated time than at the dedicated time.

54. A computer program product comprising at least one computer-readable storage medium having computer-executable program code instructions stored therein, the computer-executable program code instructions comprising:
program code instructions configured to cause receipt of an indication from a first communication device specifying data to be synchronized at a designated time in the future or at an unspecified time in the future;
program code instructions configured to cause receipt of a message from a second communication device to synchronize the data at an assigned time that is prior to the designated time;
program code instructions configured to detect a synchronization conflict, pertaining to the data, among the first communication device and the second communication device based in part on evaluating information of the indication and the message; and
program code instructions configured to enable provision of a request to the first communication device requesting fetching of content associated with the data to enable synchronization of the data at a dedicated time prior to the assigned time.

55. The computer program product of claim 54, further comprising:
program code instructions configured to enable sending of a generated message to the second communication device warning the second communication device of the synchronization conflict.

56. The computer program product of claim 55, wherein the generated message comprises information instructing the second communication device to wait to receive a no conflict message during a predefined time period prior to initiating synchronization of the data at the assigned time.

57. The computer program product of claim 54, further comprising:
program code instructions configured to synchronize the data at the dedicated time in response to receiving the fetched content and an indication, from the first communication device, specifying to synchronize the data at the dedicated time.

58. The computer program product of claim 57, wherein prior to synchronize the data, the computer program product further comprises:
program code instructions configured to cause receipt of a feedback message from the first communication device during the predefined time period indicating whether the first communication device accepts or rejects the request to fetch the content to enable the synchronization of the data at the dedicated time.

59. The computer program product of claim 57, further comprising:
program code instructions configured to enable provision of a message to the second communication device indicating that there is no longer a synchronization conflict and requesting information from the second communication device to synchronize the data at the assigned time.

60. The computer program product of claim 59, further comprising:
program code instructions configured to synchronize the data at the assigned time based in part on the information received from the second communication device.

61. The computer program product of claim 57, wherein:
the indication to synchronize the data at the dedicated time is received in response to the first communication device determining that a network connection for transfer of the content is reliable at the dedicated time or that transfer of the content costs less at the dedicated time relative to the designated time.
